(19) United States
(12) Patent Application Publication
(10) Pub. No.: US 2014/0261535 A1
(43) Pub. Date: Sep. 18, 2014

(54) Standing Wave Generation in Holes to Enhance Cleaning in the Holes in Liquid Sonification Cleaning Systems

(71) Applicant: LAM RESEARCH CORPORATION, Fremont, CA (US)

(72) Inventor: John F. Stumpf, Kettering, OH (US)

(73) Assignee: Lam Research Corporation, Fremont, CA (US)

(21) Appl. No.: 13/801,019

(22) Filed: Mar. 13, 2013

(51) Int. Cl. B08B 3/12

(52) U.S. Cl. CPC B08B 3/12
USPC 134/1

(57) ABSTRACT

Methods and liquid sonification systems configured to clean at least one hole of an article. The methods comprise establishing at least one pressure gradient within the at least one hole to move particles proximate to a node of a standing wave toward an antinode of the standing wave, the standing wave having an axis of propagation parallel to the central axis of the at least one hole. The methods may, in some embodiments, comprise establishing one or more sites of cavitation within the at least one hole.

### FIELD

This disclosure relates to liquid sonification cleaning apparatuses and methods of cleaning articles using such apparatuses, and more particularly to methods of cleaning one or more holes of an article using standing waves.

### BACKGROUND

In many industrial processes, it is often important to control contamination. For example, semiconductor substrate materials (such as silicon wafers) are processed in plasma processing chambers wherein interior and interior-facing component surfaces are exposed to deposition, etching, and stripping environments. Thus, accumulation of inorganic and organic contaminates on processing chamber component surfaces is commonly observed and can cause contamination of substrate materials, reduction in processing efficiency, or both. Thus, surfaces of new processing chamber components must be cleaned before first use, and over time, such component surfaces must be cleaned in order for them to continue to be useful. Otherwise, such components (or portions thereof) must be replaced. While the costs associated with replacement favor cleaning a component, certain components are difficult to clean, especially those having holes, cavities, passages, perforations, orifices, apertures, pores, or other openings (collectively, “holes” or “hole”).

Through the processing of semiconductor substrate materials, organic materials (for example, finger oils, grease, particles and organic compounds); metals (for example, aluminum, molybdenum, and tungsten); dielectric materials (for example, silicon dioxide and silicon nitride); and other inorganic materials can become deposited onto processing chamber component surfaces. Such contaminates are typically cleaned from a component in a liquid sonification cleaning system, such as an ultrasonic bath. However, conventional systems and cleaning methods suffer from an inability to provide particle-free, or consistently particle-free, results. This is particularly true when the component has one or more holes where particles can accumulate. Without limitation, one example of such a component is an electrode of a plasma processing chamber.

Whether cleaning plasma processing chamber components or other articles (including those used in industrial processes other than plasma processing), there remains an ongoing need for better apparatuses and methods for obtaining ultra-clean articles.

### SUMMARY

The present disclosure provides, in various embodiments, methods of cleaning one or more holes of an article, and liquid sonification cleaning systems configured therefore. More particularly, the provided systems and methods utilize standing waves to clean one or more holes of an article.

In some of the various embodiments, the methods comprise (i) providing a liquid sonification cleaning system operable to cause resonation of an article disposed in a fluid-containing acoustic chamber of the system; (ii) positioning an article having at least one hole to be cleaned in the fluid of the acoustic chamber; and (iii) establishing at least one pressure gradient within the at least one hole by applying acoustic energy sufficient to cause establishment of an ultrasonic standing wave having an axis of propagation parallel to a central hole axis. Thus, the methods comprise establishing an ultrasonic standing wave through the hole length along, or proximate to, the corresponding central axis of the hole. Ultrasonic standing waves occur as a result of incident and reflected waves that are traveling in opposite directions. The resultant superposition of the two waves forms standing waves and creates an ultrasonic radiation force. The provided methods utilize such force to establish at least one pressure gradient in the at least one hole to move particles proximate to a node of the standing wave toward an antinode of the standing wave. In some embodiments, the frequency of the acoustic energy applied is:

$${f}_{n} = \frac{n C}{2 L} Hz$$

n=a positive integer >0; C=velocity of sound in the fluid; and L=hole length. Accordingly, a standing wave having one, two, three, or more nodes within the at least one hole may be established. Thus, there may also be more than one pressure gradient established.

The methods comprise, in some of the various embodiments, establishing one or more sites of cavitation within the at least one hole, the sites of cavitation being proximate to at least one standing wave antinode. With cavitation, the gas and/or fluid content of the cleaning fluid in the hole is isolated or vaporized by the low pressure existing proximate to an antinode of the ultrasonic standing wave to generate micro bubble nuclei that grow to larger bubbles and break open with a micro explosion. Thus, cavitation creates a force which may be used to dislodge and move particles within the at least one hole. Establishing cavitation sites may be accomplished by applying acoustic energy having a frequency of:

$${f}_{n} = \frac{n C}{2 L} Hz$$

n=a positive integer ≧2; C=velocity of sound in the fluid; and L=hole length. One or more antinodes (and corresponding sites of cavitation) may be established within the hole. For example, two, three, four, five, or six antinodes may be established within the hole.

In some of the various embodiments, the provided methods comprise establishing ultrasonic standing waves in a plurality of holes of an article positioned in the fluid of the acoustic chamber. This can be achieved by determining a range of hole lengths (L) corresponding the plurality of holes existing on or within the article, calculating a range of values of fₙ with the determined values of L, and applying acoustic energy across the range of values of fₙ.

Although the present disclosure is not intended to be limited to a particular article to be cleaned or a particular application, in some embodiments the provided methods and apparatuses are configured to clean one or more components of a plasma processing chamber. For example, and not by way of limitation, one type of such component is an electrode. Accordingly, the provided methods and apparatuses may, in some embodiments, be configured to clean a showerhead electrode of a plasma processing chamber. Moreover, such apparatuses and methods may be configured to provide ultra-clean showerhead electrodes. Similarly, in some embodiments, the provided methods and apparatuses may be configured to clean showerheads of a different type, such as ones used in electroplating applications.

### BRIEF DESCRIPTION OF THE DRAWINGS

A more complete appreciation of the many embodiments of the present disclosure will be readily obtained as the same becomes better understood by reference to the following detailed description when considered in connection with the accompanying drawings, wherein:

FIG. 1 illustrates one example of a provided method;

FIG. 2 illustrates certain embodiments of the provided methods, namely how a pressure gradient can be established within at least one hole of an article to be cleaned by establishing a standing wave with one node located in the hole; and

FIG. 3 illustrates certain embodiments of the provided methods, namely how at least one pressure gradient and at least one site of cavitation can be established within at least one hole of an article to be cleaned by establishing a standing wave with at least one node and at least one antinode located in the hole.

### DETAILED DESCRIPTION

Specific embodiments of the present disclosure will now be described. The invention may, however, be embodied in different forms and should not be construed as limited to the embodiments set forth herein. Rather, these embodiments are provided so that this disclosure will be thorough and complete and will fully convey the scope of the same to those skilled in the art.

Unless otherwise defined, all technical and scientific terms used herein have the same meaning as commonly understood by one of ordinary skill in the art to which this disclosure belongs. The terminology used in the present disclosure is for describing particular embodiments only and is not intended to be limiting. As used in the specification and appended claims, the singular forms “a,” “an,” and “the” are intended to include the plural forms as well, unless the context clearly indicates otherwise.

It is noted that recitations herein of “at least one” component, element, etc., should not be used to create an inference that the alternative use of the articles “a” or “an” should be limited to a single component, element, etc.

It is noted that recitations herein of a component of the present disclosure being “configured” to embody a particular property, or function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is further noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

The terms “ultrasound” “ultrasonic,” and “ultrasound wave” mean a sound wave of a frequency higher than the audible frequency (16 kHz or higher), as well as the audible sound wave.

The term “acoustic energy,” as used herein, means energy concerning vibrations of any frequency transmitted as waves. Acoustic energy includes, but is not limited to, ultrasonic energy. Moreover, the term “acoustic energy generating element” means a device that converts electrical or mechanical energy to acoustic energy. Without limitation, such device may be a transducer, such as a piezoelectric transducer.

Unless otherwise indicated, all numbers expressing quantities, properties, conditions, and so forth as used in the specification and claims are to be understood as being modified in all instances by the term “about.” Additionally, the disclosure of any ranges in the specification and claims are to be understood as including the range itself and also anything subsumed therein, as well as endpoints. Notwithstanding that numerical ranges and parameters setting forth the broad scope of the disclosure are approximations, the numerical values set forth in the specific examples are reported as precisely as possible. Any numerical values, however, inherently contain certain errors necessarily resulting from error found in their respective measurements.

### Methods

In various embodiments of the present disclosure, provided are methods of cleaning an article. Such methods comprise providing a liquid sonification cleaning system operable to cause resonance of an article disposed in a fluid-containing acoustic chamber of the system. Further, such methods comprise properly positioning and/or orienting an article having at least one hole to be cleaned in the fluid of the acoustic chamber. Additionally, such methods comprise establishing at least one pressure gradient within the at least one hole by establishing an ultrasonic standing wave having an axis of propagation parallel to a central axis of the at least one hole. Thus, the methods involve establishing an ultrasonic standing wave through the length of the at least one hole along, or proximate to, the corresponding central hole axis (i.e., the lengthwise axis of the hole). The at least one pressure gradient that is established in the at least one hole provides a force to move particles proximate to a node of the standing wave toward an antinode of the standing wave. More than one pressure gradient may be established in a hole. For example, there may be more than one node established in a hole, each being associated with a pressure gradient.

In some embodiments, the frequency of the acoustic energy applied is:

$${f}_{n} = \frac{n C}{2 L} Hz$$

wherein n=a positive integer >0; C=velocity of sound in the fluid; and L=hole length. Typically, fₙ will be from about 1 to about 1000 kHz, but could be as high as 2000 kHz. Accordingly, in some embodiments, fₙ may be 1-100 kHz, 100-200 kHz, 200-300 kHz, 300-400 kHz, 400-500 kHz, 500-600 kHz, 600-700 kHz, 700-800 kHz, 800-900 kHz, 900-1000 kHz, 1000-1100 kHz, 1100-1200 kHz, 1200-1300 kHz, 1300-1400 kHz, 1400-1500 kHz, 1500-1600 kHz, 1600-1700 kHz, 1700-1800 kHz, 1800-1900 kHz, 1900-2000 kHz. In some examples, fₙ may be from 7.5-750 kHz. One of skill will appreciate that the value of fₙ depends upon the values of n, C, and L. In some embodiments, n may be 1, 2, 3, 4, 5, or greater. The value of n selected will depend upon, among other things, the particular cleaning application desired and article to be cleaned. The value of C (velocity of sound in the cleaning fluid) will vary depending upon the selection of cleaning fluid. In some embodiments, the cleaning fluid is water and C=1500 m/s (at 20° C.). The value of L will vary depending upon the length of the at least one hole. In some embodiments, L may be from 0.001 to 0.1 meters (m). Accordingly, L may be 1-10 mm, 10-20 mm, 20-30 mm, 30-40 mm, 40-50 mm, 50-60 mm, 60-70 mm, 70-80 mm, 80-90 mm, 90-100 mm. In certain examples, L=0.010 m. One of skill will appreciate that the methods may comprise, in some embodiments, applying acoustic energy across a plurality of values of fₙ, each being associated with a different value of n, L, or combination thereof.

The methods comprise, in some of the various embodiments, establishing one or more sites of cavitation within the at least one hole, the sites of cavitation being proximate to at least one standing wave antinode. With cavitation, the gas and/or fluid content of the cleaning fluid in the hole is isolated or vaporized by the low pressure (when lower than the vapor pressure of the fluid) existing proximate to an antinode of the ultrasonic standing wave to generate micro bubble nuclei that grow to larger bubbles and collapse/implode, thereby generating a force. Thus, cavitation creates a force expanding outward from the at least one antinode (in the hole) which may be used to dislodge and move particles within the at least one hole. Moreover, cavitation temporarily disrupts the standing wave since the fluid becomes a mixture of liquid and vapor, which changes the value of C. Therefore, as the standing wave repeatedly is disrupted and reestablished, a pumping force emanating from the hole helps to push particles out of the hole. Establishing cavitation sites may be accomplished by applying acoustic energy having a frequency of:

$${f}_{n} = \frac{n C}{2 L} Hz$$

n=a positive integer ≧2; C=velocity of sound in the cleaning fluid; and L=hole length.

One or more antinodes (and corresponding sites of cavitation) may be established within the hole. For example, two, three, four, five, or six antinodes may be established within the hole. In some embodiments, n may be 2, 3, 4, 5, or greater. The value of C will vary depending upon the selection of cleaning fluid. In some embodiments, the cleaning fluid is water and C=1500 m/s (at 20° C.). The value of L will vary depending upon the length of the at least one hole. In some embodiments, L may be from 0.001 m to 0.1 m. One of skill will appreciate that the methods may comprise, in some embodiments, establishing a plurality of cavitation sites within a single hole by applying acoustic energy across a plurality of values of fₙ, each being associated with a different value of n. One of skill will also appreciate that the methods may comprise, in some embodiments, establishing at least one cavitation site within a plurality of holes by applying acoustic energy across a plurality of values of fₙ, each being associated with a different value of L. Additionally, one of skill will appreciate that the methods may comprise, in some embodiments, establishing a plurality of cavitation sites within a plurality of holes by applying acoustic energy across a plurality of values of fₙ, each being associated with a different value of n and L.

In some embodiments of the provided methods, one or more conditions may be established in the at least one hole to be cleaned. For example, a standing wave may be established in a hole, such wave having one node within the hole and antinodes proximate to each end of the hole. Thus, a pressure gradient is established within the hole, the gradient comprising a higher pressure area proximate to the node within the hole and lower pressure areas proximate to the antinodes at the ends of the hole. Under such a condition, cavitation is not established within the hole but may be established proximate to the ends of the hole. Such a condition therefore relies solely upon the pressure gradient to provide a motive force to move particles from within the hole toward the ends of the hole. This condition may, in some embodiments, be complemented with fluid flow. As another example of a condition which may be established, a standing wave of may be established in the hole, such wave having at least one antinode within the hole. Thus, in addition to at least one pressure gradient being established within the hole, cavitation is established within the hole proximate to the at least one antinode. Such a condition therefore utilizes cavitation to dislodge particles within the hole and provide motive force to move such particles, such motive force supplementing the motive force established by the at least one pressure gradient. This condition may, in some embodiments, be complemented with fluid flow.

In some embodiments, the provided methods comprise utilizing a variety of conditions established within the at least one hole. For example, the at least one hole of an article can be subjected to the first condition described above (without cavitation), followed by being subjected to the second condition described above (with cavitation). As another example, the at least one hole of an article can be subjected to the second condition described above (with cavitation), followed by being subjected to the first condition described above (without cavitation). Other combinations of the first and second conditions described are also within the scope of the provided methods. In particular, methods involving cycling between the two conditions is specifically contemplated.

The provided methods may be configured to clean a variety of types of articles containing holes. One non-limiting example of such an article is a showerhead for use in plasma processing or electroplating applications. Accordingly, in some embodiments, the provided methods may be configured to clean a showerhead electrode of a plasma processing chamber. As one of skill in the art will appreciate, a showerhead may comprise one or more holes where particles or other contaminates may reside. For example, a showerhead may comprise one or more passages (extending from the backside to the frontside of the electrode), one or more recesses (formed in the backside of the electrode), or combinations thereof. Thus, the provided methods may, in some embodiments, be configured to clean passages, recesses, or both, of a showerhead.

The provided methods are suitable for cleaning showerheads of various materials of composition, including those comprising single crystal silicon, polysilicon, silicon nitride, silicon carbide, boron carbide, aluminum nitride, aluminum oxide, or combinations thereof. Such materials of composition may be used, for example, in showerhead electrodes. In some embodiments, the provided methods are also suitable for cleaning showerheads of other materials of composition, such as those made of metal (for example, aluminum or aluminum alloy), plastic (for example, polyethylene terephthalate, polytetrafluoroethylene, fluorinated ethylene propylene, polyvinylidene fluoride, or polyvinylidene difluoride), or combinations thereof. Such materials of composition may be used, for example, in showerheads used in electroplating applications. The provided methods are also suitable for cleaning showerhead electrodes of various configurations including, but not limited to, single-piece showerhead configurations (such as circular) or multi-component showerhead configurations. Electrodes of the latter configuration may, in some examples, comprise a circular central electrode and one or more peripheral electrodes arranged about the circumference of the central electrode.

Whether the article to be cleaned is a showerhead electrode or other article, in some embodiments of the provided methods, the article can be received within the acoustic chamber, and the cleaning fluid subsequently introduced into the acoustic chamber. Alternatively, the acoustic chamber can contain the cleaning fluid prior to the article being received in the acoustic chamber. Similarly, in some embodiments of the provided methods, the acoustic energy is generated within the acoustic chamber prior to the article being received in such chamber. Alternatively, the article can be received in the acoustic chamber and the acoustic energy subsequently generated.

The cleaning fluid utilized in the provided methods can be any fluid suitable for the application and suitable for use with ultrasound. In some embodiments, the cleaning fluid is water. However, an organic solvent, an acidic solution, or a basic solution could also be used. For example, the cleaning fluid can be selected from water (including, but not limited to, deionized water), methanol (CH₃OH), ethanol (C₂H₅OH), isopropyl alcohol (C₃H₇OH), acetone (C₃H₆O), ammonium hydroxide (NH₄OH), hydrogen peroxide (H₂O₂), potassium hydroxide (KOH), hydrochloric acid (HCl), hydrofluoric acid (HF), nitric acid (HNO₃), acetic acid (C₂H₄O₂), or combinations thereof. In the provided methods, one cleaning fluid (or combination of cleaning fluids) can be introduced into the acoustic chamber and the article contacted therewith, followed by flushing of such cleaning fluid from the acoustic chamber and subsequent introduction of a different cleaning fluid (or combination of cleaning fluids) into the acoustic chamber.

Once cleaning fluid has been introduced into the acoustic chamber, it is excited by ultrasonic waves. The level of ultrasonic power used can be that suitable for a particular application and article. For example, the power could be selected such that cavitation occurs only in a hole of an article. The power will also vary depending upon the fluid volume in the acoustic chamber. For example, power density may be 0-10 W/in², 10-20 W/in², 20-30 W/in², 30-40 W/in², 40-50 W/in², 50-60 W/in², 60-70 W/in², or 70-80 W/in². In some embodiments, ultrasonic waves may be introduced at a continuous power density (for example, continuously at 25 W/in²). In some embodiments, the ultrasonic source of the apparatus may have an adjustable frequency or strength of waves to be generated and such waves are introduced at a variable power density (for example, initially at 15 W/in² and subsequently at 25 W/in²). Cycle time (contact time with ultrasonic waves) can also be suited to the particular application and article to be cleaned. As non-limiting examples, the cycle time can be 1, 2, 3, 4, 5, 6, 7, 8, 9, or 10 minutes. One of skill will also appreciate that cycle time can be less than one minute.

In those embodiments wherein the provided system may be configured to direct flow of cleaning fluid in the acoustic chamber, the provided methods may comprise orienting the article within the acoustic chamber such that the fluid flow is substantially parallel with or substantially perpendicular to the central axis of the at least one hole. It is also contemplated that fluid flow could be both parallel and perpendicular to the central axis of the at least one hole and that the provided system can be accordingly configured. Regardless of the particular combinations of article orientation within the chamber, the at least one hole will—in the provided methods—be oriented such that a standing ultrasonic wave is established within the hole. More particularly, the standing wave is established such that its axis of propagation (and reflection) is parallel to the central axis of the hole. Accordingly, the axis of propagation may be the same as the central axis of the hole. The provided methods, in certain embodiments, are configured for cleaning showerhead electrodes. In such methods, the showerhead electrode is received within the acoustic chamber such that the central axis of the at least one hole to be cleaned is oriented parallel to an axis of propagation of an ultrasonic wave. Accordingly, the at least one hole may be oriented substantially perpendicular to the acoustic generating element. However, one of skill will appreciate that orientation of the at least one hole with respect to the generating element can vary without deviating from the scope of the provided methods, so long as the axis of propagation of the ultrasonic wave remains parallel to the central axis of the at least one hole.

In various embodiments, the provided methods comprise establishing ultrasonic standing waves in a plurality of article holes. To do so, a range of values of L, each value corresponding to one of the plurality of holes, is determined. One of skill will appreciate, however, that it is not always necessary to physically measure the length of each hole of the plurality of holes. For example, an article may be manufactured to have a plurality of holes of length Y, but when accounting for standard manufacturing tolerances, the holes may have a plurality of lengths ranging from X-Z. Once a range of values of L have been determined, a range of values of fₙ can be calculated with the determined values of L. In some embodiments, for each value of L, it may also be desirable to determine a range of values of fₙ, each being associated with a different value of n. Once a range of values of fₙ have been determined, acoustic energy is applied to the acoustic chamber and article disposed therein across the range of values of fₙ, thereby establishing ultrasonic standing waves (of one or more fₙ) in a plurality of article holes. In some embodiments, this can be accomplished using a sweep frequency transducer that vibrates within a certain range. For example, within 5-7% of a determined fₙ. The provided methods, in certain embodiments, are configured for cleaning showerhead electrodes. In such methods, acoustic energy is applied to the acoustic chamber and showerhead electrode disposed therein across the range of values of fₙ determined, thereby establishing ultrasonic standing waves (of one or more fₙ) in a plurality of holes of the showerhead electrode.

### Apparatus

In various embodiments of the present disclosure, provided is a liquid sonification cleaning system configured to cause resonance of an article disposed therein. Such system may comprise an ultrasonic bath.

In some of the various embodiments, the provided system comprises at least one acoustic energy generating element coupled to an acoustic chamber configured to contain a fluid. Thus, the provided system may comprise an ultrasonic transducer coupled to an ultrasonic tank comprising a cleaning fluid. Various configurations of the acoustic energy generating element, with respect to the acoustic chamber, are specifically contemplated. For example, the generating element may be in the bottom or in one or more sides of the chamber.

The acoustic energy generating element may be a variable frequency or multi-frequency generator. While acoustic energy generating elements are generally familiar to those of skill in the art, a suitable one for the provided system is a piezoelectric transducer capable of providing a suitable power density, and requisite frequency (fₙ), for a contemplated application. The size and shape of the acoustic chamber are some factors in selection of a suitable generating element. Regardless of size and shape of the acoustic chamber, the acoustic energy generating element must be capable of generating acoustic energy having a frequency according to:

$${f}_{n} = \frac{n C}{2 L} Hz$$

wherein n=a positive integer >0; C=velocity of sound in the cleaning fluid; and L=article hole length. Typically, fₙ will be from about 1 to about 1000 kHz, but could be as high as 2000 kHz. Accordingly, in some embodiments, the provided apparatus must be sufficient to generate a fₙ of 1-100 kHz, 100-200 kHz, 200-300 kHz, 300-400 kHz, 400-500 kHz, 500-600 kHz, 600-700 kHz, 700-800 kHz, 800-900 kHz, 900-1000 kHz, 1000-1100 kHz, 1100-1200 kHz, 1200-1300 kHz, 1300-1400 kHz, 1400-1500 kHz, 1500-1600 kHz, 1600-1700 kHz, 1700-1800 kHz, 1800-1900 kHz, 1900-2000 kHz. Additionally, in some embodiments, the provided apparatus is configured to apply acoustic energy across a plurality of values of fₙ In some embodiments, the acoustic energy generating element may be a sweep frequency transducer that vibrates within a certain range of a mean frequency.

The system is operable to cause resonance of an article disposed within the acoustic chamber and fluid contained therein, the resonance occurring as a result of incident and reflected waves through one or more holes of the article. The standing waves create ultrasonic radiation pressure through the one or more holes, such pressure being harnessed to assist in the cleaning of particles from the one or more holes. Thus, the provided system must be capable of establishing at least one standing wave through at least one hole of an article to be cleaned.

In some embodiments, the provided apparatus is configured to establish one or more sites of cavitation within the at least one hole to be cleaned, each site of cavitation being proximate to at least one standing wave antinode. In some embodiments, the apparatus can be configured to establish cavitation in only the hole of an article. Accordingly, the provided system may be configured to apply to the acoustic chamber (and article disposed therein) acoustic energy having a frequency of:

$${f}_{n} = \frac{n C}{2 L} Hz$$

n=a positive integer ≧2; C=velocity of sound in the cleaning fluid; and L=hole length. Thus, the system may be configured to establish within an article hole one or more antinodes (and corresponding sites of cavitation). For example, two, three, four, five, or six antinodes may be established within the hole, each antinode being proximate to one or more sites of cavitation. One of skill will appreciate that the provided apparatus may be configured, in some embodiments, to establish a plurality of cavitation sites within a single hole by applying acoustic energy across a plurality of values of fₙ, each being associated with a different value of n. One of skill will also appreciate that the provided apparatus may, in some embodiments, be configured to establish at least one cavitation site within a plurality of holes by applying acoustic energy across a plurality of values of fₙ, each being associated with a different value of L. Additionally, one of skill will appreciate that the provided apparatus may be configured to establish, in some embodiments, a plurality of cavitation sites within a plurality of holes by applying acoustic energy across a plurality of values of fₙ, each being associated with a different value of n and L.

In addition to an acoustic energy generating element and acoustic chamber, the provided system may, in some embodiments, comprise at least one acoustic energy receiver. Upon contact with an object, an acoustic energy wave emanating from the generating element and having an axis of propagation is reflected back along the axis of propagation, yielding a standing wave. An acoustic energy receiver can detect reflected waves, including but not limited to, standing waves. In some embodiments, the receiver is distinct from the acoustic energy generating element. However, in some embodiments, the acoustic energy generating element may be a transceiver capable of generating acoustic energy as well as detecting reflected waves. In some embodiments, the acoustic energy receiver is coupled to a feedback mechanism (such as a transducer), whereby an electric signal is generated upon detection of an increased sound pressure amplitude associated with resonance of the at least one hole of the article being achieved. Thus, the acoustic energy receiver may be used to detect, monitor, and/or control cleaning of the article holes. For example, power can be increased until resonance is detected and then maintained so that resonance stays active. In those embodiments where cavitation is not desired, this feedback can be used to ensure that power is not increased to a point where cavitation occurs. In those embodiments where cavitation is desired, this feedback can be used to monitor the cycling of the standing wave and cavitation. Moreover, in those embodiments where cavitation is desired solely in the holes of the article, this feedback can be used to control power such that only the desired cavitation pattern occurs.

As indicated, the receiver may be the basis of a feedback mechanism. Such receiver may be, or may be used in conjunction with, optical receivers. For example, one or more cameras, in conjunction with video processing software, could be used to monitor the holes for cavitation. The optical receivers may also be used to provide a quality control mechanism in order to know that all holes experienced cavitation for a specified length of time.

In some embodiments, the provided system is configured to direct cleaning fluid such that particles removed from an article are carried away from the article. Accordingly, the provided system may comprise one or more fluid inlets for delivering a cleaning fluid, such inlets being in fluid communication with the acoustic chamber. In some embodiments, the system is configured to have a flow of fluid through the acoustic chamber that is substantially perpendicular to the at least one hole of the article to be cleaned. Thus, as particles are removed from such hole and emerge from one or both ends thereof, they are swept by the flow of fluid in a direction substantially perpendicular to the central axis of the hole. In some embodiments, the system is configured to have a flow of fluid through the acoustic chamber that is substantially parallel to at least one hole of an article to be cleaned. Thus, as particles are removed from such hole they are swept by a flow of fluid through the hole and emerge from one or both ends thereof. One of skill in the art will appreciate that the flow of fluid through the acoustic chamber may be configured to be both perpendicular and parallel to the at least one hole. Moreover, one of skill will also appreciate that other fluid flow configurations are also contemplated.

To aid in the cleaning of the article disposed in the acoustic chamber, the provided system may, in some embodiments, comprise one or more article supports. Thus, the article to be cleaned may be maintained by a support in the cleaning fluid above the bottom of the acoustic chamber. Moreover, the support may be configured to maintain the article (and holes thereof) in a specific orientation relative to the acoustic energy generator, the acoustic energy receiver, or both. For example, the support may be configured to orient one or more holes to be perpendicular to the acoustic energy generating element. Additionally, the support may be configured to maintain the article (and holes thereof) in a specific orientation relative to the flow of cleaning fluid. For example, the support may be configured to orient one or more holes to be perpendicular to the flow of fluid in the acoustic chamber.

In certain embodiments, the provided system is specifically configured to receive and clean plasma processing chamber components, including without limitation, showerhead electrodes. In such embodiments, the acoustic chamber is configured to receive a showerhead electrode comprising at least one hole to be cleaned. A showerhead electrode may comprise multiple holes to be cleaned. Regardless of the number of holes to be cleaned, the system is configured to receive the showerhead electrode such that an ultrasonic standing wave is established with an axis of propagation parallel to a central axis of the at least one hole, the central axis spanning the length of the hole. In such embodiments, at least the interior of the hole is contacted with ultrasonic waves. Optionally, other portions of the showerhead electrode may also be contacted with ultrasonic waves. In either instance, the system is configured to remove particles from the hole and carry them away from the showerhead electrode hole. Thus, the system is suitable for use in providing an ultra-clean showerhead electrode.

In certain embodiments, the provided system may be specifically configured to receive and clean showerheads used in electroplating applications. The configuration of the system will be substantially similar to that described with respect to showerhead electrodes.

### EXAMPLES

The described embodiments will be better understood by reference to the following examples which are offered by way of illustration and which one of skill in the art will recognize are not meant to be limiting.

### Example 1

In some of the various embodiments of the present disclosure, provided are methods of cleaning one or more holes of an article. As illustrated in FIG. 1, such methods may, in one example 100, comprise 110 providing a liquid sonification cleaning system. Such system may comprise at least one acoustic energy generating element, an acoustic chamber containing a fluid, and (optionally) at least one acoustic energy receiver. Such method 100 may further comprise 120 positioning an article having at least one hole to be cleaned in the fluid of the acoustic chamber such that a standing wave may be established in the at least one hole. In some embodiments, the at least one hole may be oriented substantially perpendicular to the acoustic energy generating element. Additionally, such method 100 may further comprise establishing at least one pressure gradient within the at least one hole. The pressure gradient is established by applying acoustic energy to the acoustic chamber and article disposed therein to create an ultrasonic standing wave having (i) an axis of propagation parallel to an axis of hole length (central axis); and (ii) a frequency of:

$${f}_{n} = \frac{n C}{2 L} Hz$$

n=a positive integer >0; C=velocity of sound in the fluid; and L=hole length. The frequency applied will depend upon 130 determining whether or not cavitation is desired.

In some embodiments, the method 100 may comprise 140 establishing one or more sites of cavitation within the at least one hole. The one or more sites of cavitation are established by applying acoustic energy to the acoustic chamber and article disposed therein such that the ultrasonic standing wave has a frequency of:

$${f}_{n} = \frac{n C}{2 L} Hz$$

n=a positive integer ≧2; C=velocity of sound in the fluid; and L=hole length. Thus, said cavitation sites are proximate to one or more antinodes established within the at least one hole.

If cavitation is not desired, the method 100 comprises 160 establishing within the at least one hole a standing wave a node but no antinodes within the at least one hole. In such embodiments, n=1.

In some embodiments, the method 100 may further comprise 150 cycling between (i) a condition wherein a node but no antinodes are established within the at least one hole, and (ii) a condition wherein at least one node and at least one antinode are established within the at least one hole. The cycling may be done one, two, three, four, or more times.

### Example 2

As illustrated in FIG. 2, the provided apparatus and methods may be configured to clean at least one hole 200 of an article. At least one pressure gradient may be established within the at least one hole 200 by applying acoustic energy to create an ultrasonic standing wave 210 having (i) an axis of propagation (not labeled) parallel to an axis of hole length 220; and (ii) a frequency of:

$${f}_{n} = \frac{n C}{2 L} Hz$$

n=a positive integer >0; C=velocity of sound in the fluid; and L=hole length.

For example if the cleaning fluid is water and the hole length is 0.010 m, the frequency would be:

$${f}_{1} = \frac{( 1 ) ( 1500 m \text{/} s )}{( 2 ) ( 0.010 m )} = 75 \text{,} 000 Hz$$

As shown, applying acoustic energy having f₁=75,000 Hz would establish a standing wave 210 having a node 230 within the hole 200 and antinodes 240, 250 proximate to the hole 200 ends (not labeled). Nodes 230 are sites of higher pressure, and antinodes 240, 250 are sites of lower pressure, and as such, a pressure gradient 260 is established within the hole 200. Accordingly, a motive force is established to move particles from a higher pressure area (within the hole 200) toward the lower pressure areas (near the antinodes 240, 250). Under the illustrated condition, cavitation does not occur within the hole 200, or if it does, it is only proximate to the ends. Thus, such a condition relies upon the pressure gradient 260 to provide a motive force to remove particles. However, the removal of particles may, in some embodiments, be aided by flow of fluid through the hole 200, perpendicular to the hole 200, or both.

### Example 3

As illustrated in FIG. 3, the provided apparatus and methods may be configured to clean at least one hole 300 of an article. At least one pressure gradient may be established within the at least one hole 300 by applying acoustic energy to create an ultrasonic standing wave 310 having (i) an axis of propagation (not labeled) parallel to an axis of hole length 320; and (ii) a frequency of:

$${f}_{n} = \frac{n C}{2 L} Hz$$

n=a positive integer ≧2; C=velocity of sound in the fluid; and L=hole length.

For example if the cleaning fluid is water and the hole length is 0.010 m, the frequency would be:

$${f}_{2} = \frac{( 2 ) ( 1500 m \text{/} s )}{( 2 ) ( 0.010 m )} = 150 \text{,} 000 Hz$$

As shown, applying acoustic energy having f₂=150,000 Hz would establish a standing wave 310 having more than one node 330, 340 within the hole 300 and at least one antinode 350 within the hole 300, as well as antinodes 360, 370 proximate to the hole 300 ends (not labeled). Nodes 330, 340 are sites of higher pressure, and antinodes 350, 360, 370 are sites of lower pressure, and as such, at least one pressure gradient 380, 390 is established within the hole 300. Accordingly, a motive force is established to move particles from a higher pressure area (within the hole 300) toward the lower pressure areas (near the antinodes 350, 360, 370). Under the illustrated condition, cavitation does occur within the hole 300 proximate to the at least one antinode 350 disposed therein, as well as proximate to the ends. Thus, such a condition relies upon the at least one pressure gradient 380, 390, as well as cavitation to dislodge and move particles from within the hole 300 towards the ends. The removal of particles may, in some embodiments, be aided by flow of fluid through the hole 300, perpendicular to the hole 300, or both. In further embodiments, additional antinodes (and sites of cavitation) can be established in the hole 300 by increasing the value of “n” in the formula fₙ.

The present disclosure should not be considered limited to the specific examples described herein. Various modifications, equivalent processes, as well as numerous structures and devices to which the present disclosure may be applicable will be readily apparent to those of skill in the art. Those skilled in the art will understand that various changes may be made without departing from the scope of the disclosure, which is not to be considered limited to what is described in the specification.

What is claimed is:

1. Method of cleaning one or more holes of an article, comprising:
providing a liquid sonification cleaning system comprising at least one acoustic energy generating element, an acoustic chamber containing a fluid, the system operable to cause resonation of an article disposed in the acoustic chamber;
positioning an article having at least one hole to be cleaned in the fluid of the acoustic chamber such that the at least one hole is oriented with respect to the acoustic energy generating element such that the at least one hole is capable of resonance upon application of acoustic energy thereto;
establishing at least one pressure gradient within the at least one hole by applying acoustic energy to the acoustic chamber and article disposed therein to create an ultrasonic standing wave having (i) an axis of propagation parallel to an axis of hole length; and (ii) a frequency of:
$${f}_{n} = \frac{n C}{2 L} Hz$$
n=a positive integer >0; C=velocity of sound in the fluid; and L=hole length; and
wherein the at least one pressure gradient provides a force to move particles proximate to a node of the standing wave toward an antinode of the standing wave.

2. A method according to claim 1, comprising establishing one or more sites of cavitation within the at least one hole by applying acoustic energy to the acoustic chamber and article disposed therein such that the ultrasonic standing wave has a frequency of:
$${f}_{n} = \frac{n C}{2 L} Hz$$
n=a positive integer ≧2; C=velocity of sound in the fluid; and L=hole length; and
wherein the sites of cavitation are proximate to at least one antinode established within the at least one hole and create a force to dislodge and move particles therein.

3. A method according to claim 1, wherein the acoustic energy generating element is a variable frequency or multi-frequency ultrasonic generator.

4. A method according to claim 1, wherein the liquid sonification cleaning system is configured to have a flow of fluid through the acoustic chamber that is substantially perpendicular to the at least one hole of the article, substantially parallel to the at least one hole of the article, or both.

5. A method according to claim 1, wherein the liquid sonification cleaning system comprises an acoustic energy receiver, an optical receiver, or both, and the method comprises monitoring cleaning of the at least one hole using said receiver.

6. A method according to claim 1, comprising establishing ultrasonic standing waves in a plurality of article holes by (a) determining a range of values of L corresponding the plurality of holes; (b) calculating a range of values of fₙ with the determined values of L; and (c) applying acoustic energy to the acoustic chamber and article disposed therein across the range of values of fₙ.

7. A method according to claim 6, wherein n≧2.

8. A method according to claim 1, wherein the article is a showerhead.

9. A method of cleaning one or more holes of a showerhead, comprising:
providing a liquid sonification cleaning system comprising at least one variable frequency or multi-frequency ultrasonic generating element, an acoustic chamber containing a fluid, and at least one receiver selected from an ultrasonic receiver and an optical receiver, the system operable to cause resonation of a showerhead disposed in the acoustic chamber;
positioning a showerhead having at least one hole to be cleaned in the fluid of the acoustic chamber such that the at least one hole is oriented substantially perpendicular to the ultrasonic generating element, the at least one hole being capable of resonance upon application of ultrasonic energy thereto;
establishing one or more sites of cavitation within the at least one hole by applying ultrasonic energy to the acoustic chamber and showerhead disposed therein to create an ultrasonic standing wave having (i) an axis of propagation parallel to an axis of hole length; (ii) at least one antinode positioned within the at least one hole; and (iii) a frequency of:
$${f}_{n} = \frac{n C}{2 L} Hz$$
n=a positive integer ≧2; C=velocity of sound in the fluid; and L=hole length; and
wherein the sites of cavitation are proximate to at least one antinode and create a force within the at least one hole to dislodge and move particles therein.

10. A method according to claim 9, further comprising establishing at least one pressure gradient within the at least one hole by applying ultrasonic energy to the acoustic chamber and showerhead disposed therein such that the ultrasonic standing wave has a frequency of:
$${f}_{n} = \frac{n C}{2 L} Hz$$
n=1; C=velocity of sound in the fluid; and L=hole length;
wherein the at least one pressure gradient provides a force to move particles proximate to a node of the standing wave within the at least one hole toward an antinode of the standing wave proximate to an end of the at least one hole.

11. A method according to claim 9, comprising monitoring cleaning of the at least one hole using the at least one receiver.

12. A method according to claim 9, wherein the liquid sonification cleaning system is configured to have a flow of fluid through the acoustic chamber that is substantially perpendicular to the at least one hole of the showerhead, substantially parallel to the at least one hole, or both.

13. A method according to claim 9, comprising establishing ultrasonic standing waves in a plurality of showerhead holes by (a) determining a range of values of L corresponding the plurality of holes; (b) calculating a range of values of fₙ with the determined values of L; and (c) applying acoustic energy to the acoustic chamber and showerhead disposed therein across the range of values of fₙ.

14. A method according to claim 10, comprising establishing ultrasonic standing waves in a plurality of showerhead holes by (a) determining a range of values of L corresponding the plurality of holes; (b) calculating a range of values of fₙ with the determined values of L; and (c) applying acoustic energy to the acoustic chamber and showerhead disposed therein across the range of values of fₙ.

15. Method of cleaning one or more holes of showerhead electrode, comprising:
providing a liquid sonification cleaning system comprising at least one variable frequency or multi-frequency ultrasonic generating element, an acoustic chamber containing a fluid, and at least one receiver selected from an ultrasonic receiver and an optical receiver, the system operable to cause resonation of showerhead electrode disposed in the acoustic chamber;
positioning a showerhead electrode having a plurality of holes to be cleaned in the fluid of the acoustic chamber such that the plurality of holes is aligned substantially perpendicular to the ultrasonic generating element, each hole being capable of resonance upon application of ultrasonic energy thereto;
determining a range of values of L corresponding the plurality of holes and calculating a range of values of fₙ with the determined values of L;
wherein
$${f}_{n} = \frac{n C}{2 L} Hz ;$$
n=a positive integer >0; C=velocity of sound in the fluid; and L=hole length; and
applying ultrasonic energy to the acoustic chamber and showerhead electrode disposed therein to cause within each hole (a) an ultrasonic standing wave having an axis of propagation parallel to an axis of hole length; and (b) one or both of (i) at least one pressure gradient providing a force to move particles proximate to a node of the standing wave toward an anode of the standing wave; and (ii) one or more sites of cavitation creating a force to dislodge and move particles, the sites of cavitation being proximate to at least one antinode positioned within the hole, n being ≧2.

16. A method according to claim 15, comprising applying the ultrasonic energy such that a pressure gradient having a single node within each hole and antinodes proximate to hole ends is established, but no sites of cavitation within the hole are established.

17. A method according to claim 15, comprising applying the ultrasonic energy such that one or more sites of cavitation are established within each hole, but no pressure gradients having n<2 are established.

18. A method according to claim 15, wherein the liquid sonification cleaning system is configured to have a flow of fluid through the acoustic chamber that is substantially perpendicular to the plurality of holes, substantially parallel to the plurality of holes, or both.

19. A method according to claim 15, comprising monitoring cleaning of the plurality of holes using an ultrasonic receiver.

20. A method according to claim 15, comprising monitoring cleaning of the plurality of holes using an optical receiver.
